(19) United States
(12) Patent Application Publication
(10) Pub. No.: US 2015/0304362 A1
(43) Pub. Date: Oct. 22, 2015

(54) INFORMATION PROCESSING SYSTEM, INFORMATION PROCESSING APPARATUS, METHOD, AND STORAGE MEDIUM

(71) Applicant: Osamu OGAWARA, Kanagawa (JP)

(72) Inventor: Osamu OGAWARA, Kanagawa (JP)

(21) Appl. No.: 14/688,090

(22) Filed: Apr. 16, 2015

(30) Foreign Application Priority Data
Apr. 21, 2014 (JP) 2014-087348

(51) Int. Cl. H04L 29/06

(52) U.S. Cl. CPC H04L 65/1069

(57) ABSTRACT

An information processing system includes a first information processing apparatus used as a connection requester, and a second information processing apparatus used as a connection destination. The first information processing apparatus includes a connection destination detector to detect the second information processing apparatus by transmitting a response request, a display controller to selectively display a plurality of connection information input screens on a display of the first information processing apparatus depending on a condition of a network that the first information processing apparatus belongs, and a network that the second information processing apparatus belongs, in which the connection information input screens are useable for inputting information required for communication connection with the second information processing apparatus, and a connection processing unit to perform communication connection with the second information processing apparatus by using information input to one or more of the plurality of connection information input screens.

### CROSS-REFERENCE TO RELATED APPLICATION

This application claims priority pursuant to 35 U.S.C. §119(a) to Japanese Patent Application No. 2014-087348, filed on Apr. 21, 2014 in the Japan Patent Office, the disclosure of which are incorporated by reference herein in their entirety.

### BACKGROUND

1. Technical Field

The present invention relates to an information processing system used for data communication among a plurality of information processing apparatuses, and more particularly to an information processing system, an information processing apparatus, a method, and storage medium of a program for establishing communication connection among a plurality of information processing apparatuses.

2. Background Art

Electronic display boards are used in companies, educational organizations, administration organizations or the like when meetings and presentations are held, in which the electronic display boards display images supplied from information processing apparatuses such as user personal computer (PC) or the like. When images are supplied from the user PC to the electronic display board, data communication is required to be established between the user PC and the electronic display board by using various communication connection technologies.

One of the communication connection technologies discloses a method of setting connection between apparatuses, in which information of an external apparatus is acquired from the external apparatus connected to a network, and when the external apparatus was connected in the past, the external apparatus is automatically connected without a user operation, and when the external apparatus was not connected in the past, apparatus information is presented to a user and the user is requested to select a to-be-connected external apparatus. In this method, a digital video camera used as a connection requester transmits search packets via a network, and an external apparatus that transmits a response is displayed on a display as a user interface (UI), which is displayable only when a response is received.

Typically, when search packets are transmitted via a network, the search packets are transmitted to a sub-network where the digital video camera used as a connection requester belongs. Therefore, if a sub-network that the digital video camera (i.e., connection requester) belongs and a sub-network that an external apparatus (i.e., connection destination), to be connected by a user, belongs are different, the to-be-connected external apparatus cannot be displayed on a display as UI, and thereby the user cannot connect the digital video camera to the external apparatus.

### SUMMARY

In one aspect of the present invention, an information processing system for a plurality of information processing apparatuses is devised. The information processing system includes a first information processing apparatus used as a connection requester including one or more processing circuits, and a second information processing apparatus used as a connection destination to be connected with the first information processing apparatus. The first information processing apparatus includes a connection destination detector to detect the second information processing apparatus used as the connection destination by transmitting a response request, a display controller to selectively display a plurality of connection information input screens on a display of the first information processing apparatus used as the connection requester depending on a condition of a network that the first information processing apparatus belongs, and a network that the second information processing apparatus belongs, in which the connection information input screens are useable for inputting information required for communication connection with the second information processing apparatus used as the connection destination, and a connection processing unit to perform communication connection with the second information processing apparatus used as the connection destination by using information input to one or more of the plurality of connection information input screens displayed on the display.

In another aspect of the present invention, an information processing apparatus used as a connection requester, including one or more processing circuits, for communicating with an information processing apparatus used as a connection destination is devised. The information processing apparatus used as the connection requester includes a connection destination detector to detect the information processing apparatus used as the connection destination by transmitting a response request, a display controller to selectively display a plurality of connection information input screens on a display of the information processing apparatus used as the connection requester depending on a condition of a network that the information processing apparatus used as the connection requester belongs, and a network that the information processing apparatus used as the connection destination belongs, in which the connection information input screens are useable for inputting information required for communication connection with the information processing apparatus used as the connection destination, and a connection processing unit to perform communication connection with the information processing apparatus used as the connection destination by using information input to one or more of the plurality of connection information input screens displayed on the display.

In another aspect of the present invention, a method of establishing communication between an information processing apparatus used as a connection requester, and an information processing apparatus used as a connection destination is devised. The method includes he steps of transmitting a response request from the information processing apparatus used as the connection requester, detecting the information processing apparatus used as the connection destination, selectively displaying a plurality of connection information input screens on a display of the information processing apparatus used as the connection requester depending on a condition of a network that the information processing apparatus used as the connection requester belongs, and a network that the information processing apparatus used as the connection destination belongs, the connection information input screens useable for inputting information required for communication connection with the information processing apparatus used as the connection destination, and performing communication connection between the information processing apparatus used as the connection requester, and the information processing apparatus used as the connection destination by using information input to one or more of the plurality of connection information input screens displayed on the display.

### BRIEF DESCRIPTION OF THE DRAWINGS

A more complete appreciation of the disclosure and many of the attendant advantages and features thereof can be readily obtained and understood from the following detailed description with reference to the accompanying drawings, wherein:

FIG. 1 is a scheme of an information processing system according to an example embodiment;

FIG. 2 is an example of hardware configuration of a user PC;

FIG. 3 is a functional block diagram of the user PC of FIG. 2;

FIG. 4 is a sequential chart of a process performable by the information processing system according to an example embodiment;

FIG. 5 is a flowchart showing the steps of a process performable by the user PC of FIG. 2; and

FIG. 6 are examples of connection information input screens displayable by an information processing apparatus according to an example embodiment.

The accompanying drawings are intended to depict exemplary embodiments of the present invention and should not be interpreted to limit the scope thereof. The accompanying drawings are not to be considered as drawn to scale unless explicitly noted, and identical or similar reference numerals designate identical or similar components throughout the several views.

### DETAILED DESCRIPTION

A description is now given of exemplary embodiments of the present invention. It should be noted that although such terms as first, second, etc. may be used herein to describe various elements, components, regions, layers and/or sections, it should be understood that such elements, components, regions, layers and/or sections are not limited thereby because such terms are relative, that is, used only to distinguish one element, component, region, layer or section from another region, layer or section. Thus, for example, a first element, component, region, layer or section discussed below could be termed a second element, component, region, layer or section without departing from the teachings of the present invention.

In addition, it should be noted that the terminology used herein is for the purpose of describing particular embodiments only and is not intended to be limiting of the present invention. Thus, for example, as used herein, the singular forms “a”, “an” and “the” are intended to include the plural forms as well, unless the context clearly indicates otherwise. Moreover, the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Furthermore, although in describing views shown in the drawings, specific terminology is employed for the sake of clarity, the present disclosure is not limited to the specific terminology so selected and it is to be understood that each specific element includes all technical equivalents that operate in a similar manner and achieve a similar result. Referring now to the drawings, apparatus or system according to one or more example embodiments are described hereinafter.

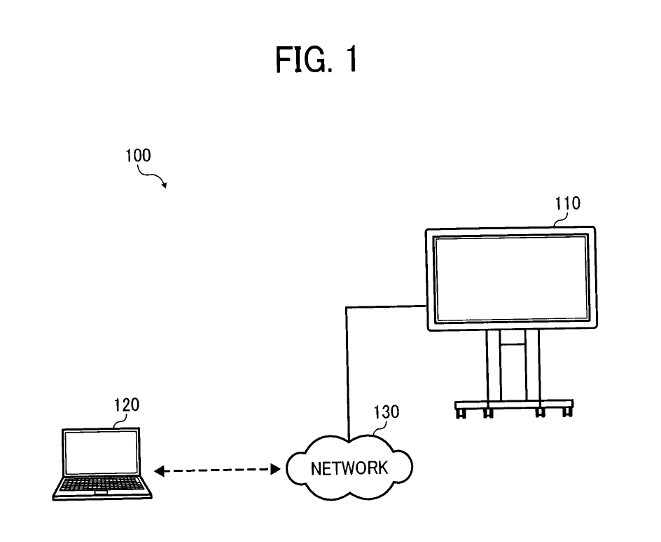

FIG. 1 is a scheme of an information processing system 100 according to an example embodiment. The information processing system 100 includes, information processing apparatuses such as an electronic display board 110, and a user personal computer (PC) 120, which can communicate with each other via a network 130. The network 130 can be wired local area network (LAN) and/or wireless LAN, but not limited hereto.

The electronic display board 110 is one example of information processing apparatus, which can display images. For example, the electronic display board 110 can communicate with the user PC 120 via the network 130, and display images supplied from the user PC 120.

The user PC 120 is one example of information processing apparatus, which can supply images to the electronic display board 110. For example, the user PC 120 can communicate with the electronic display board 110 via an access point of wireless communication and the network 130. In a case of FIG. 1, the user PC 120 is a laptop computer, but various information processing apparatuses such as smart phones, tablet PCs or the like can be used as the user PC 120. Although FIG. 1 illustrates the information processing system 100 including one electronic display board, and one user PC, the number of electronic display boards and user PCs can be changed as required.

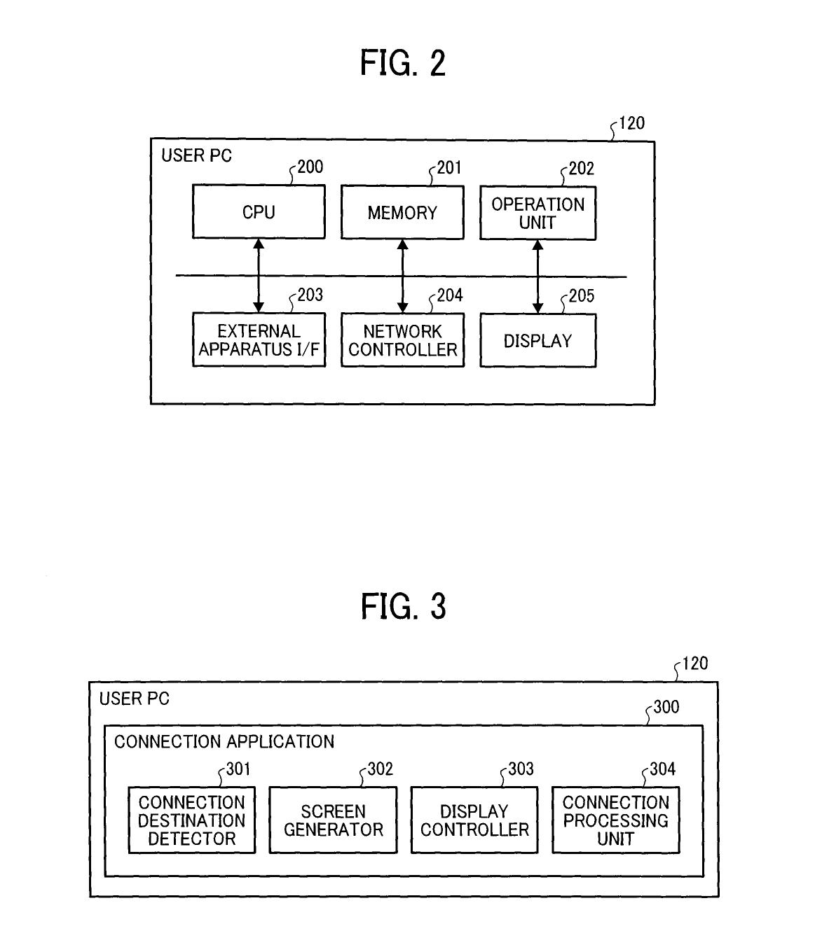

FIG. 2 is an example of hardware configuration of user PC 120. As illustrated in FIG. 2, the user PC 120 includes, for example, a central processing unit (CPU) 200, a memory 201, an operation unit 202, an external apparatus interface (I/F) 203, a network controller 204, and a display 205.

The CPU 200 is a computing device such a processor, processing circuit, and circuitry that executes one or more programs according to an example embodiment. The memory 201 is a storage or a storage device that stores data such as the programs according to an example embodiment, and is devised as a read only memory (ROM), a random access memory (RAM), a hard disk drive (HDD) or the like. For example, the CPU 200 reads the programs from the HDD and loads and executes the programs on the RAM under a control of various operating systems (OS) to implement to-be-described functions on the user PC 120.

The operation unit 202 is used to receive instructions from a user. For example, the operation unit 202 can be a key board, a touch panel or the like. The external apparatus interface (I/F) 203 is an interface that can be connected to various external apparatuses such as a mouse, a key board or the like. The network controller 204 is a controller that controls communication via the network 130. The display 205 can be various display devices such as liquid crystal display, organic electro luminescence (EL) display or the like that can display various images.

FIG. 3 is a functional block diagram of the user PC 120. A description is given of the functional block diagram of the user PC 120 with reference to FIG. 3.

As illustrated in FIG. 3, the user PC 120 includes, for example, a connection application 300 that establishes communication connection with one or more of an information processing apparatuses that can be connected to the user PC 120. As illustrated in FIG. 3, the connection application 300 includes, for example, a connection destination detector 301, a screen generator 302, a display controller 303, and a connection processing unit 304.

The connection destination detector 301 is a detector that detects an information processing apparatus that can be connected to the user PC 120 for communication. The connection destination detector 301 broadcasts a response request to the network 130. When an information processing apparatus returns a response to the response request transmitted from the connection destination detector 301, the connection destination detector 301 can detect that the information processing apparatus that has returned the response as a connection destination. Further, the connection destination detector 301 can transmit a response request to a sub-network that the user PC 120, used as a connection requester, belongs, and a sub-network designated by a user.

In one configuration, service set identifier (SSID) can be used as connection information for establishing a connection between information processing apparatuses. For example, information processing apparatuses can be configured to store SSID by including identification information indicating that a concerned information processing apparatus can communicate with the user PC 120 in the SSID. When the SSID (i.e., connection information) of an information processing apparatus detected by the connection destination detector 301 includes the identification information, the connection destination detector 301 can detect that the information processing apparatus having set with the SSID is a connection destination.

The screen generator 302 is a generator that generates a plurality of screens to be displayed on the display 205. For example, the screen generator 302 can generate a plurality of connection information input screens, used for inputting connection information required for communication connection with a connection destination such as an information processing apparatus.

The display controller 303 is a controller that controls the display 205. Specifically, the display controller 303 selectively displays a plurality of connection information input screens on the display 205 depending on a condition of a network that the user PC 120 (i.e., connection requester) belongs. For example, the display controller 303 selectively displays a plurality of connection information input screens depending on whether a sub-network that the user PC 120 belongs, and a sub-network that an information processing apparatus (i.e., connection destination) belongs are different or the same. Further, the display controller 303 selectively displays a plurality of connection information input screens depending on whether a sub-network that is designated by a user, and a sub-network that an information processing apparatus (i.e., connection destination) belongs are different or the same.

The connection processing unit 304 is used to establish communication connection between the user PC 120 (i.e., connection requester) and an information processing apparatus (i.e., connection destination) that can communicate with the user PC 120. Specifically, the connection processing unit 304 transmits connection information and connection request, input from the connection information input screen by a user operation, to an information processing apparatus used as the connection destination, and establishes communication connection with the information processing apparatus used as the connection destination.

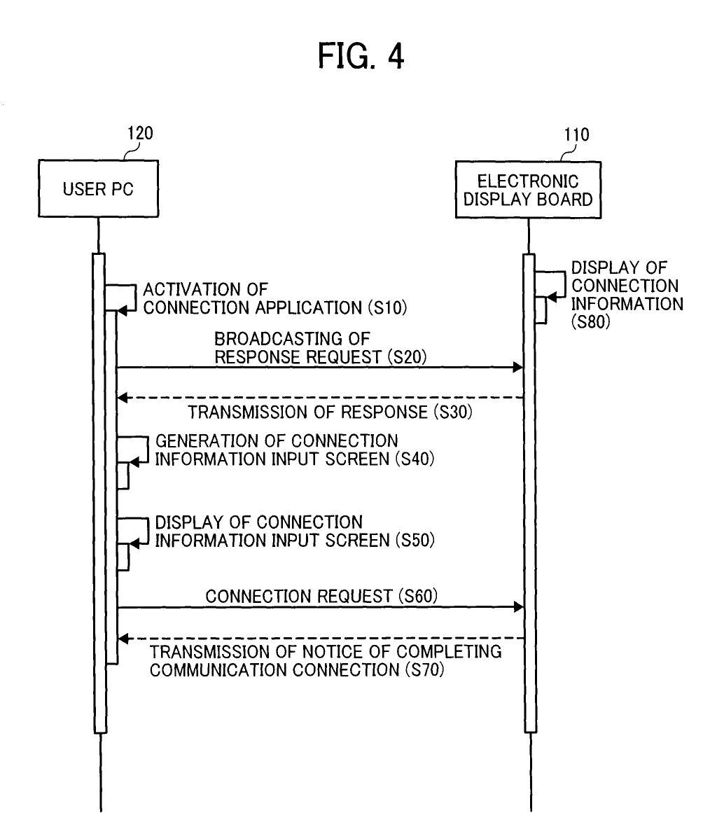

FIG. 4 is a sequential chart of a process performable by the information processing system 100. A description is given of a process of establishing communication connection between the user PC 120 and the electronic display board 110 by with reference to FIG. 4, in which the user PC 120 is used as a connection requester, and the electronic display board 110 is used as a connection destination.

When a user instructs the user PC 120 to activate the connection application 300 (S10), the user PC 120 activates the connection application 300, and the connection application 300 broadcasts a response request, which can be processed by an information processing apparatus such as the electronic display board 110 that can be connected with the user PC 120 for communication (S20).

When the electronic display board 110, which can be connected with the user PC 120 for communication, receives the response request, the electronic display board 110 transmits a response to the received response request to the user PC 120 (S30) with an interne protocol (IP) address of the electronic display board 110 (S30).

When the user PC 120 receives the response from the electronic display board 110, the connection application 300 generates and displays a connection information input screen on the display 205 (S40, S50). Further, the electronic display board 110 displays connection information on a display of the electronic display board 110 (S80). When a user inputs the connection information, displayed and presented by the electronic display board 110, to the connection information input screen, the connection application 300 transmits the connection request and connection information to the electronic display board 110 (S60). When the electronic display board 110 receives the connection request from the user PC 120, the electronic display board 110 establishes communication connection with the user PC 120, and transmits a notice that the communication connection is completed (S70).

In the configuration of FIG. 4, the connection application 300 transmits a response request when activated (S10, S20), but not limited hereto. In another configuration, the connection application 300 can transmit a response request periodically, in which even if the activation of information processing apparatus used as a connection destination is delayed, the information processing apparatus can be detected as a connection destination.

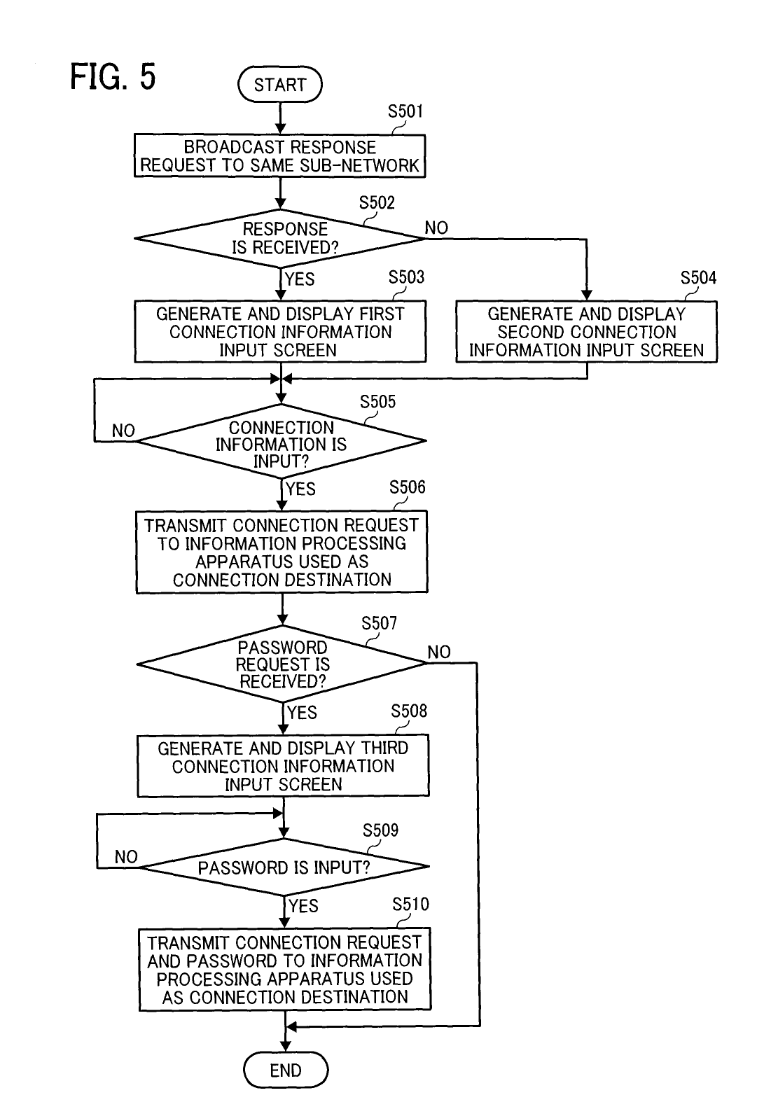

FIG. 5 is a flowchart showing the steps of a process performable by the user PC 120 according to an example embodiment. A description is given of a process performable by the connection application 300 of the user PC 120 when establishing communication connection with an information processing apparatus used as a connection destination by using the connection application 300 with reference to FIG. 5.

At step S501, the connection destination detector 301 broadcasts a response request to a sub-network, which is the same sub-network of the network 130 that the user PC 120 belongs.

In this configuration, the user PC 120 broadcasts the response request to the sub-network, which is the same sub-network that the user PC 120 belongs, but not limited hereto. In another configuration, the user PC 120 can broadcast a response request to a sub-network in the network 130 designated by a user. In still another configuration, the user PC 120 can broadcast a response request to a plurality of sub-networks, including a sub-network that the user PC 120 belongs, in which the plurality of sub-networks can be designated by a user.

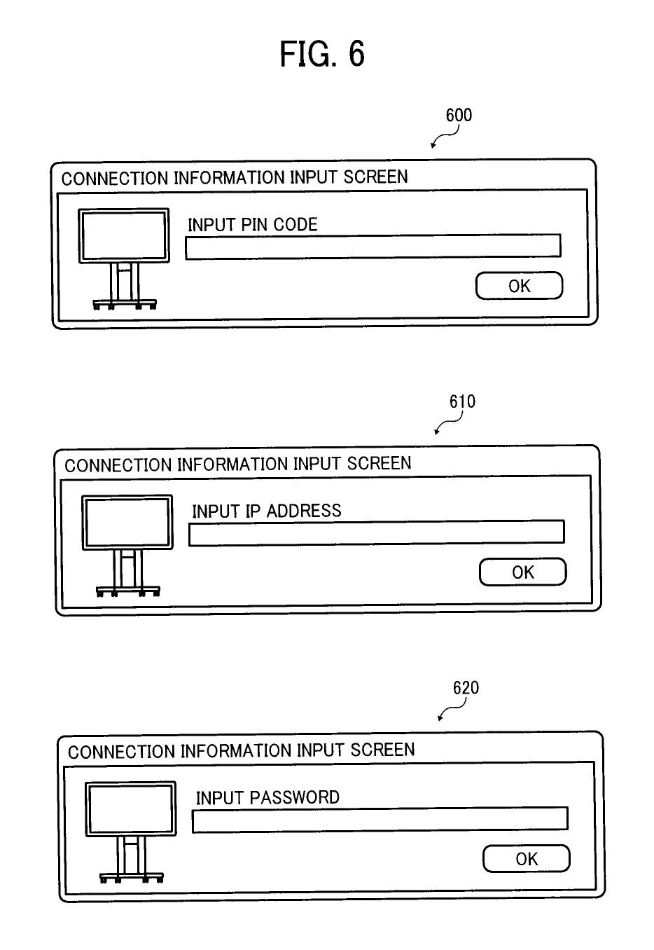

At step S502, the connection destination detector 301 determines whether a response to the response request, transmitted at S501, is received. If the response is received (S502: YES), the sequence proceeds to step S503. At step S503, the screen generator 302 generates a first connection information input screen such as a connection information input screen 600 (see FIG. 6), and the display controller 303 displays the first connection information input screen on the display 205 (S503).

By contrast, if the response is not received (S502: NO), the sequence proceeds to step S504. At step S504, the screen generator 302 generates a second connection information input screen such as a connection information input screen 610 (see FIG. 6), and the display controller 303 displays the second connection information input screen on the display 205 (S504).

At step S505, the connection processing unit 304 determines whether connection information is input to the first or the second connection information input screen by a user. If the connection information is not input (S505: NO), the process of step S505 is repeated. By contrast, if the connection information is input (S505: YES), the sequence proceeds to step S506.

At step S506, the connection processing unit 304 transmits a connection request to an information processing apparatus used as a connection destination. Specifically, when a connection code assigned to the information processing apparatus, used as the connection destination, is input as connection information, the connection processing unit 304 transmits a connection request and the connection code to the information processing apparatus (i.e., connection destination) that has returned the response. When the IP address assigned to the information processing apparatus (i.e., connection destination) is input as connection information, the connection processing unit 304 transmits a connection request to the information processing apparatus designated by the IP address.

At step S507, the connection processing unit 304 determines whether the connection processing unit 304 receives a password request from the information processing apparatus (i.e., connection destination) as a response to the connection request transmitted to the information processing apparatus. If the password request is not received (S507: NO), the process ends. By contrast, if the password request is received (S507: YES), the sequence proceeds to step S508.

At step S508, the screen generator 302 generates a third connection information input screen such as a connection information input screen 620 (see FIG. 6), and the display controller 303 displays the third connection information input screen on the display 205. At step S509, the connection processing unit 304 determines whether a password is input to the third connection information input screen by the user. If the password is not input (S509: NO), the process of step S509 is repeated.

By contrast, if the password is input (S509: YES), the sequence proceeds to step S510. At step S510, the connection processing unit 304 transmits the connection request and password to the information processing apparatus used as the connection destination, and then the process ends. The information processing apparatus (i.e., connection destination), which has received the connection request and password, verifies the password transmitted from the connection processing unit 304. If the password is correct, the information processing apparatus establishes communication connection with the user PC 120, and transmits a notice of completion of communication connection to the user PC 120.

As above described, the user PC 120 can selectively display a plurality of connection information input screens, used for inputting different connection information, depending on a condition of a network that the user PC 120 belongs. Specifically, depending on whether a sub-network that the user PC 120 (i.e., connection requester) belongs and a sub-network that the information processing apparatus (i.e., connection destination) belongs are different or the same, the user PC 120 displays different connection information input screens, with which information required for communication connection can be selectively requested to a user. With this configuration, the user can set communication connection easily based on the connection information input screen displayed on the display 205, with which usability when establishing the communication connection can be enhanced.

FIG. 6 are examples of connection information input screens displayable by the user PC 120 according to an example embodiment. The connection information input screen 600 is a screen used for inputting a connection code assigned to an information processing apparatus used as a connection destination. In an example of FIG. 6, the connection code is, for example, personal identification number (PIN) code. The format of connection code (e.g., type of connection code such as numbers and characters, number of digits, number of characters, prohibited characters) can be set in advance, with which the connection application 300 can prohibit an input of connection code not complied with a given format.

The connection information input screen 600 is displayed when a response request is transmitted to a sub-network that the user PC 120 belongs, and a response is received from an information processing apparatus that belongs to the same sub-network. Further, the connection information input screen 600 is displayed when a response request is transmitted to a sub-network that the user PC 120 does not belong, and a response is received from an information processing apparatus that belongs to a sub-network designated by a user.

The connection information input screen 610 is a screen used for inputting address information such as IP address assigned to an information processing apparatus used as a connection destination. The format of IP address (e.g., number of digits, prohibited characters) can be set in advance, with which the connection application 300 can prohibit an input of connection code not complied with a given format.

The connection information input screen 610 is displayed when a response request is transmitted to a sub-network that the user PC 120 belongs, and a response is received from an information processing apparatus that belongs to a sub-network that the user PC 120 does not belong. Further, the connection information input screen 610 is displayed when a response request is transmitted to a sub-network that the user PC 120 does not belong, and a response is received from an information processing apparatus that belongs to a sub-network, which is different from a sub-network designated by a user.

The connection information input screen 620 is a screen used for inputting a password required for communication connection with an information processing apparatus used as a connection destination. The connection information input screen 620 is input with a password, which is requested from the information processing apparatus used as the connection destination. The connection information input screen 620 is displayed when the information processing apparatus used as the connection destination requests a password.

As to the above described information processing system, information processing apparatus, method, and program according to the example embodiment, information required for communication connection between two or more information processing apparatuses can be selectively requested to a user depending on a condition of a network that an information processing apparatus used as connection requester belongs and a network that an information processing apparatus used as connection destination belongs.

The present invention can be implemented in any convenient form, for example using dedicated hardware platform, or a mixture of dedicated hardware platform and software. Each of the functions of the described embodiments may be implemented by one or more processing circuits or circuitry. Processing circuitry includes a programmed processor, as a processor includes circuitry. A processing circuit also includes devices such as an application specific integrated circuit (ASIC) and conventional circuit components arranged to perform the recited functions. For example, in some embodiments, any one of the information processing apparatus may include a plurality of computing devices, e.g., a server cluster, that are configured to communicate with each other over any type of communication links, including a network, a shared memory, etc. to collectively perform the processes disclosed herein.

The computer software can be provided to the programmable device using any storage medium or carrier medium such as non-volatile memory for storing processor-readable code such as a floppy disk, a compact disk read only memory (CD-ROM), a compact disk rewritable (CD-RW), a digital versatile disk read only memory (DVD-ROM), DVD recording only/rewritable (DVD-R/RW), electrically erasable and programmable read only memory (EEPROM), erasable programmable read only memory (EPROM), a memory card or stick such as USB memory, a memory chip, a mini disk (MD), a magneto optical disc (MO), magnetic tape, a hard disk in a server, a flash memory, Blu-ray disc (registered trademark), SD card, a solid state memory device or the like, but not limited these. Further, the computer software can be provided through communication lines such as electrical communication line. Further, the computer software can be provided in a read only memory (ROM) disposed for the computer. The computer software stored in the storage medium can be installed to the computer and executed to implement the above described processing. The computer software stored in the storage medium or an external apparatus can be downloaded and installed to the computer via a network to implement the above described processing.

The hardware platform includes any desired kind of hardware resources including, for example, a central processing unit (CPU), a random access memory (RAM), and a hard disk drive (HDD). The CPU may be implemented by any desired kind of any desired number of processors. The RAM may be implemented by any desired kind of volatile or non-volatile memory. The HDD may be implemented by any desired kind of non-volatile memory capable of storing a large amount of data. The hardware resources may additionally include an input device, an output device, or a network device, depending on the type of apparatus. Alternatively, the HDD may be provided outside of the apparatus as long as the HDD is accessible. In this example, the CPU, such as a cache memory of the CPU, and the RAM may function as a physical memory or a primary memory of the apparatus, while the HDD may function as a secondary memory of the apparatus.

In the above-described example embodiment, a computer can be used with a computer-readable program, described by object-oriented programming languages such as C++, Java (registered trademark), JavaScript (registered trademark), Perl, Ruby, or legacy programming languages such as machine language, assembler language to control functional units used for the apparatus or system. For example, a particular computer (e.g., personal computer, workstation) may control an information processing apparatus or an image processing apparatus such as image forming apparatus using a computer-readable program, which can execute the above-described processes or steps.

Numerous additional modifications and variations for the communication terminal, information processing system, and information processing method, a program to execute the information processing method by a computer, and a storage or carrier medium of the program are possible in light of the above teachings. It is therefore to be understood that within the scope of the appended claims, the disclosure of the present invention may be practiced otherwise than as specifically described herein. For example, elements and/or features of different examples and illustrative embodiments may be combined each other and/or substituted for each other within the scope of this disclosure and append

What is claimed is:

1. An information processing system for a plurality of information processing apparatuses, comprising:
a first information processing apparatus used as a connection requester including one or more processing circuits; and
a second information processing apparatus used as a connection destination to be connected with the first information processing apparatus;
the first information processing apparatus comprising:
a connection destination detector to detect the second information processing apparatus used as the connection destination by transmitting a response request;
a display controller to selectively display a plurality of connection information input screens on a display of the first information processing apparatus used as the connection requester depending on a condition of a network that the first information processing apparatus belongs, and a network that the second information processing apparatus belongs, the connection information input screens useable for inputting information required for communication connection with the second information processing apparatus used as the connection destination; and
a connection processing unit to perform communication connection with the second information processing apparatus used as the connection destination by using information input to one or more of the plurality of connection information input screens displayed on the display.

2. The information processing system of claim 1, wherein the connection destination detector transmits a response request to a sub-network, which is the same sub-network that the first information processing apparatus used as the connection requester belongs, and
the display controller selectively displays the plurality of connection information input screens depending on a condition whether the sub-network that the first information processing apparatus used as the connection requester belongs, and a sub-network that the second information processing apparatus used as the connection destination belongs are different or the same.

3. The information processing system of claim 1, wherein the connection destination detector transmits a response request to a sub-network designated by a designation operation, and
the display controller selectively displays the plurality of connection information input screens depending on a condition whether the designated sub-network, and a sub-network that the second information processing apparatus used as the connection destination belongs are different or the same.

4. An information processing apparatus used as a connection requester,
including one or more processing circuits, for communicating with an information processing apparatus used as a connection destination, the information processing apparatus used as the connection requester comprising;
a connection destination detector to detect the information processing apparatus used as the connection destination by transmitting a response request;
a display controller to selectively display a plurality of connection information input screens on a display of the information processing apparatus used as the connection requester depending on a condition of a network that the information processing apparatus used as the connection requester belongs, and a network that the information processing apparatus used as the connection destination belongs, the connection information input screens useable for inputting information required for communication connection with the information processing apparatus used as the connection destination; and
a connection processing unit to perform communication connection with the information processing apparatus used as the connection destination by using information input to one or more of the plurality of connection information input screens displayed on the display.

5. The information processing system of claim 4, wherein the connection destination detector transmits a response request to a sub-network, which is the same sub-network that the information processing apparatus used as the connection requester belongs, and
the display controller selectively displays the plurality of connection information input screens depending on a condition whether the sub-network that the first information processing apparatus used as the connection requester belongs, and a sub-network that the second information processing apparatus used as the connection destination belongs are different or the same.

6. The information processing system of claim 4, wherein the connection destination detector transmits a response request to a sub-network designated by an designation operation, and
the display controller selectively displays the plurality of connection information input screens depending on a condition whether the designated sub-network, and a sub-network that the second information processing apparatus used as the connection destination belongs are different or the same.

7. A method of establishing communication between an information processing apparatus used as a connection requester, and an information processing apparatus used as a connection destination, the method comprising the steps of:
transmitting a response request from the information processing apparatus used as the connection requester;
detecting the information processing apparatus used as the connection destination;
selectively displaying a plurality of connection information input screens on a display of the information processing apparatus used as the connection requester depending on a condition of a network that the information processing apparatus used as the connection requester belongs, and a network that the information processing apparatus used as the connection destination belongs, the connection information input screens useable for inputting information required for communication connection with the information processing apparatus used as the connection destination; and
performing communication connection between the information processing apparatus used as the connection requester, and the information processing apparatus used as the connection destination by using information input to one or more of the plurality of connection information input screens displayed on the display.

8. The method of claim 7, wherein the detecting step includes transmitting a response request to a sub-network, which is the same sub-network that the information processing apparatus used as the connection requester belongs, and
the displaying step includes selectively displaying the plurality of connection information input screens depending on a condition whether a sub-network that the information processing apparatus used as the connection requester belongs, and a sub-network that the information processing apparatus used as the connection destination belongs are different or the same.

9. The method of claim 7, wherein the detecting step includes transmitting a response request to a sub-network designated by a designation operation, and
the displaying step includes selectively displaying the plurality of connection information input screens depending on a condition whether the designated sub-network, and a sub-network that the information processing apparatus used as the connection destination belongs are different or the same.

10. A non-transitory computer-readable storage medium storing a program that, when executed by a computer, causes the computer to execute the method of claim 7.
